(19) United States
(12) Patent Application Publication
(10) Pub. No.: US 2008/0060689 A1
(43) Pub. Date: Mar. 13, 2008

(54) Washing apparatus for an electric shaver

(75) Inventors: Shinichi Takizawa, Matsumoto (JP); Tetsuhiko Shimizu, Matsumoto (JP); Yoshiyuki Mimura, Matsumoto (JP); Ikuya Usui, Matsumoto (JP)

Correspondence Address: Quinn Emanuel Urquhart Oliver & Hedges. LLP;Koda/Androlia, 10th Floor, 865 S. Figueroa Street, Los Angeles, CA, 90017, US

(73) Assignee: IZUMI PRODUCTS COMPANY

(21) Appl. No.: 11/899,704

(22) Filed: Sep. 7, 2007

(30) Foreign Application Priority Data
Sep. 8, 2006 (JP) 2006-244173

(51) Int. Cl. A45D 27/46; A45D 27/48; B08B 3/04

(52) U.S. Cl. 134/57 R; 134/105

(57) ABSTRACT

A washing apparatus for an electric shaver for flushing the shaver head unit of an electric shaver with a washing liquid to wash the shaver head unit, including a washer main body for holding the shaver head unit, a washing liquid tank mounted in the washer main body and storing the washing liquid therein, a pipe provided in the washer main body and conducting the washing liquid from the washing liquid tank to the shaver head unit, a heater for heating the washing liquid passing through the pipe, and a liquid discharger for discharging the used (dirty) washing liquid that has washed the shaver head unit.

### BACKGROUND OF THE INVENTION

1. Field of the Invention

The present invention relates to a washing apparatus for electric shavers that uses a washing liquid to wash away hair debris, skin oils and the like that have collected in the shaver head unit of an electric shaver.

2. Description of the Related Art

Washing apparatuses for shavers have been proposed; and in a typical washing apparatus, the shaver head unit of an electric shaver is held, oriented downward, in a shaver holder, washing liquid is sent from a washing liquid tank to the shaver head unit of the shaver, thus washing the shaver head unit, and then the washing liquid that has washed the shaver head unit is recycled so as to return to the washing liquid in the same washing liquid tank.

In the washing apparatus disclosed in PCT International Publication No. 2001-512337, the washing liquid at room temperature is circulated between a washing liquid tank and the shaver head unit of a shaver. However, to the outer cutter(s) and inner cutter(s) inside the shaver head unit, skin oils also adhere, together with hair cuttings (“hair debris”), and these fine hair debris is hardened by these oils to a substantially solid form; as a result, such stubborn soiling as this is not easily removed and cleaned when it is merely soaked by room-temperature washing liquid. For this reason, it is necessary to use special washing liquids that have strong washing power, and thus, it becomes necessary for users to purchase specially prepared washing liquids. This is problematic in that, besides being inconvenient, such washing liquids are expensive.

Furthermore, because the washing liquid is recycled and used repeatedly, foul odors tend to be emitted from the washing liquid, which makes the user disinclined to use the washing apparatus aggressively. Generally, the washing liquid being circulated is passed through a filter(s); however, it is very difficult to adequately remove contaminants dissolved in the washing liquid even when it passes through a filter(s), resulting in that adequate shaver head unit cleaning is unable to be accomplished. This has also been a problem.

Ordinary water or a liquid mixture of water and a neutral detergent could be used instead of a specially prepared washing liquid. However, it is known that when ordinary water or a liquid mixture of such a detergent and water is conducted into the shaver head unit, the skin oils are actually hardened, making the removal thereof either impossible or extremely inefficient.

### BRIEF SUMMARY OF THE INVENTION

Accordingly, the object of the present invention, devised in view of such circumstances of the conventional washing apparatus, is to provide a washing apparatus for an electric shaver that efficiently removes hair debris, skin oils and the like, without a use of a special washing liquid, so that users no longer need to purchase a special washing liquid, and so that foul odors are not produced, thus promoting aggressive use of the washing apparatus.

The above object is accomplished by a unique structure of the present invention for a washing apparatus for an electric shaver for flushing the shaver head unit of an electric shaver with a washing liquid to wash the shaver head unit, and this washing apparatus comprises:
a washer main body for holding the shaver head unit;
a washing liquid tank mounted in the washer main body and storing the washing liquid therein;
a pipe provided in the washer main body and conducting the washing liquid from the washing liquid tank to the shaver head unit;
a heater for heating the washing liquid passing through the pipe; and
a liquid discharge means for discharging the used (dirty) washing liquid that has washed the shaver head unit.

In this washing apparatus for a shaver of the present invention, the washing liquid is heated by the heater and conducted to the head unit of a shaver (“shaver head unit”), so that high-temperature washing liquid heats, softens, and dissolves the adhering skin oils inside the shaver head unit, and such oils can be easily flushed out together with the washing liquid and hair debris. Accordingly, the shaver head unit can be washed very efficiently. Because of such a structure of the present invention as described above, plain water or aqueous solutions of a commonly used neutral detergent can be used as the washing liquid, and the inconvenience and cost of having to purchase a special washing liquid is avoidable.

Furthermore, the used (dirty) washing liquid is discharged by the liquid discharge means after it has been used to wash the shaver head unit and is not recycled. means after it has been used to wash the shaver head unit and is not recycled. Accordingly, no foul odors are produced from the washing liquid, and aggressive use of the washing apparatus by the user can be promoted.

In the present invention, the liquid discharge means can a pipe or other passageway for discharging, to the outside, the used washing liquid that has passed through the shaver head unit while washing the shaver head unit. However, the liquid discharge means can be a liquid discharge tank for accumulating used (dirty) washing liquid that has flowed down by gravity from the shaver head unit. In this structure, discharge liquid disposal is done in a simple manner.

In addition, the liquid discharge tank can be designed so as to be detachable with respect to the washer main body, and this structure is even more convenient to dispose of the discharge water (i.e. the used (dirty) washing liquid).

So as to have the used washing liquid that has passed through the shaver head unit be collected and to conduct it to the liquid discharge means (inclusive of a liquid discharge tank), the electric shaver is held so that the shaver head unit is oriented downward, and so that the used washing liquid is accumulated in a washing basin that encloses this shaver head unit from below and is then conducted to the liquid discharge means. Such a washing basin can take various shapes including a basket shape, a cup shape and the like, into which the entire shaver head unit is inserted.

In the washing apparatus of the present invention, it possible to adopt a scheme (hereinafter called “immersion scheme”) in which the washing liquid is introduced into the washing basin up to a certain liquid level, and the shaver head unit is immersed from above. It is also possible to adopt an “interior liquid injection scheme.” In this interior liquid injection scheme, the shaver head unit is formed with a liquid intake opening that allows the interior and exterior of the shaver head unit to be communicated with each other. With this liquid intake opening, fresh clean washing liquid is caused to flow into the interior of the shaver head unit through the liquid intake opening, thus cleaning the interior of the shaver head unit, and the used (dirty) washing liquid is discharged through the hair introduction openings (slits or holes) formed in the outer cutter(s) of the shaver.

In the above-described immersion scheme, a liquid discharge port is provided in the bottom of the washing basin, and in addition, an overflow port is formed in the washing basin so as to be above the liquid discharge port in order to prevent overflow of the washing liquid from the washing basin. With this structure, the liquid level of the washing liquid is prevented from rising higher than the overflow port. Any washing liquid that overflows from this overflow port is discharged by the liquid discharge means.

In the present invention, in order to conduct the washing liquid from the washing liquid tank to the shaver head unit, the position of the washing liquid tank is set to be higher than the shaver head unit of the shaver to be cleaned so that the washing liquid is made to flow down by gravity. Instead, it is also possible to provide separately a washing liquid transporting means midway along a pipe that connects the washing liquid tank and the shaver head unit. In this structure that includes the washing liquid transporting means, the heights of the washing liquid tank and shaver head unit can be set freely, increasing the freedom of design choice.

Such a washing liquid transporting means can be comprised of, for example, a heater and a check valve, in which the heater is for heating the washing liquid at a position that is midway along the pipe and lower than the washing liquid tank, and the check valve is provided upstream (on the washing liquid tank side) of this heater. In this structure, the washing liquid inside the pipe is heated by the heater so that it boils, and the boiled washing liquid is pushed out (sprayed out) to the shaver head unit, while fresh washing liquid will open the check valve, due to the water height differential (difference in the heights of the liquid levels) between the liquid level in the washing liquid tank and the position of the heater, and flow to the heater position. Instead of employing the washing liquid transporting means that uses the heater and the check valve, an electric pump can employed. When an electric pump is used, the washing liquid tank and heater can be set freely height-wise, which increases the freedom of design choice.

In order to prevent, when either using or not using the washing apparatus, fresh washing liquid from flowing out to the shaver head unit unwantedly or accidentally or to prevent used (dirty) washing liquid from the shaver head unit from flowing back to the washing liquid tank, a part of the pipe (a part of the pipe downstream from the heater, for example) can be bent so that the bent portion of the pipe is located at a position higher than the highest liquid level of the liquid in the washing liquid tank. Furthermore, an on-off valve of an electromagnetic type (solenoid on-off valve), for example, can be provided in the pipe.

In the present invention, it is preferable that the temperature of the washing liquid heated by the heater and the heater temperature be controlled so that they are held at a target set temperature. For example, the temperature of the washing liquid entering the shaver head unit, or the heater temperature, that is, at least one or the other, is detected by a temperature sensor, and the volume of heat outputted by the heater is controlled so that that temperature becomes a certain temperature (the target set temperature). Furthermore, when the washing liquid transporting means is formed by an electric pump, the temperature of the washing liquid may also be controlled by controlling the discharge volume (liquid delivery volume) of this pump. Moreover, the heat output volume of the heater and the discharge volume of the electric pump can be both controlled.

In the present invention, a means for drying the shaver head unit after the shaver head unit has been washed can be provided. With this structure, the electric shaver can be used shortly after it is washed, which is convenient. Such a drying means can be a heater that is independently provided for heating the shaver head unit. This drying heater can also double as the heater that heats up the washing liquid. The drying means can a blower that sends out a warm air flow to the washed shaver head unit. This blower sends a warm flow of air which is the air surrounding the heater and is heated by the heater that heats up the washing liquid.

It is preferable that, when the electric shaver is being washed, the power of the shaver be controlled so that the shaver is turned on for a prescribed period of time and have the shaver head unit of the electric shaver put in an operating condition so that the inner cutter(s) of the shaver is rotated or reciprocated. In this case, since the inner cutter(s) inside the shaver head unit will operate, in other words it (they) either turns (in rotary shavers) or reciprocates (in reciprocating shavers), washing of the shaver head unit is promoted, and the washing time can be shortened. It is preferable that a controller be provided in the washer main body so as to be connectable to the electric shaver, so that it controls not only the electric shaver (that is, it actuates the rotary or reciprocating inner cutter(s)) but also the washing apparatus (that is, it controls the volume of heat outputted by the heater, operating time, and the like). The operating time for the drying means may also be controlled by this controller.

In the present invention, the washing liquid can be ordinary water; and in this case, the user can use tap water, which is convenient, and disposal of the used (dirty) washing liquid can be easily done. Nevertheless, the washing liquid can also be an aqueous solution in which a detergent such as a neutral detergent is added to water.

### BRIEF DESCRIPTION OF THE SEVERAL VIEWS OF THE DRAWINGS

FIG. 1 is a side cross-sectional view of the washing apparatus for shavers according to one embodiment of the present invention;

FIG. 2 is a side cross-sectional view of the washing apparatus of FIG. 1, showing the operation thereof with a part of the apparatus omitted;

FIG. 3 is a simplified schematic diagram showing the electrical connections in the washing apparatus;

FIG. 4 is an operational flow chart of the washing apparatus;

FIG. 5 is a side cross-sectional view of the washing apparatus for shavers according to another embodiment of the present invention;

FIG. 6 is a side cross-sectional view of the washing apparatus for shavers according to still another embodiment of the present invention;

FIG. 7 is a side cross-sectional view of the washing apparatus for shavers according to further still another embodiment of the present invention; and

FIG. 8 is a side cross-sectional view of the washing apparatus of FIG. 7, showing the manner of setting a shaver in the washing apparatus.

### DETAILED DESCRIPTION OF THE INVENTION

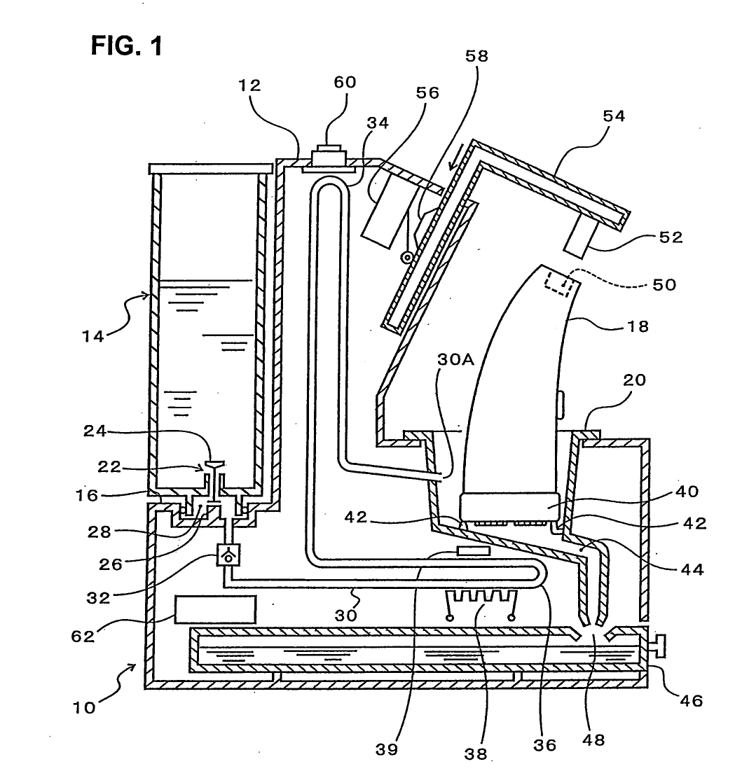

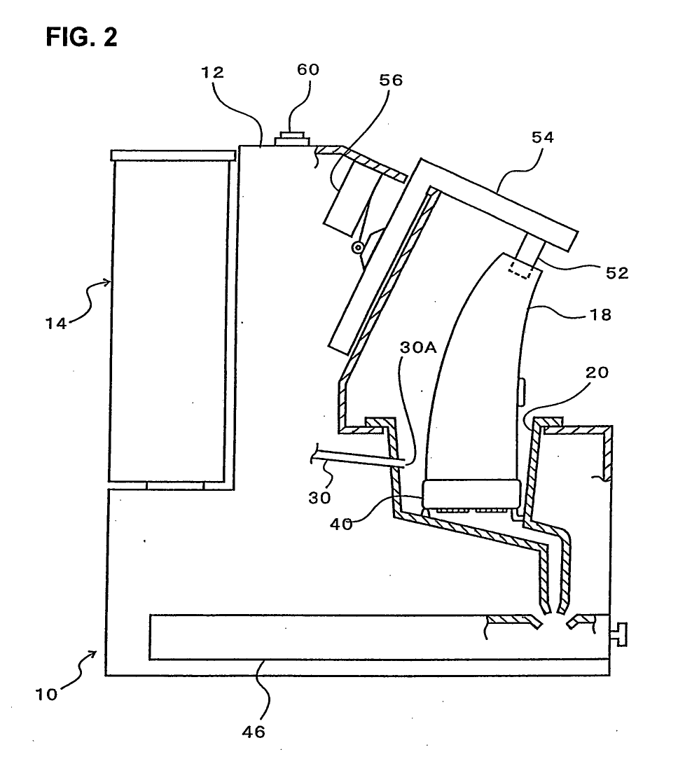

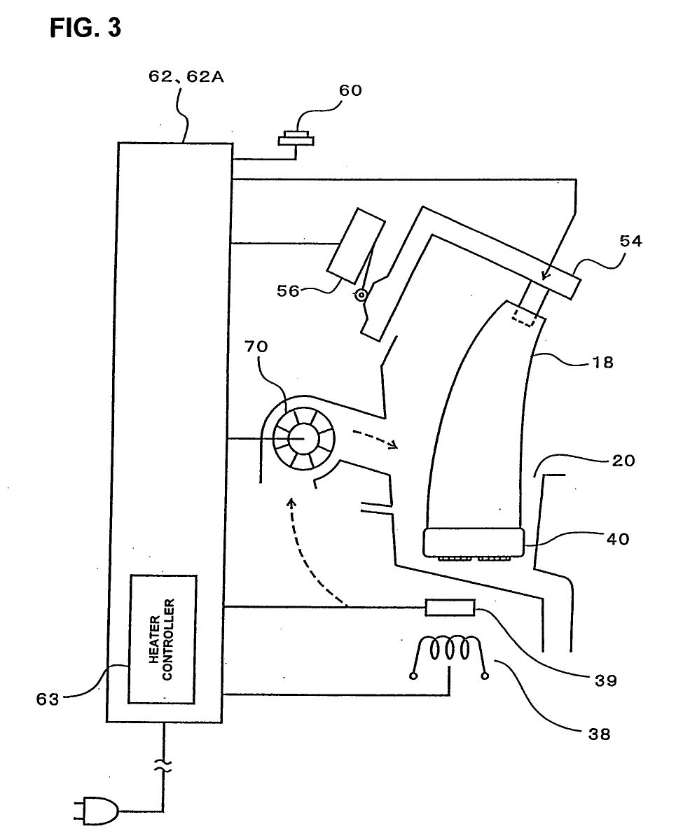

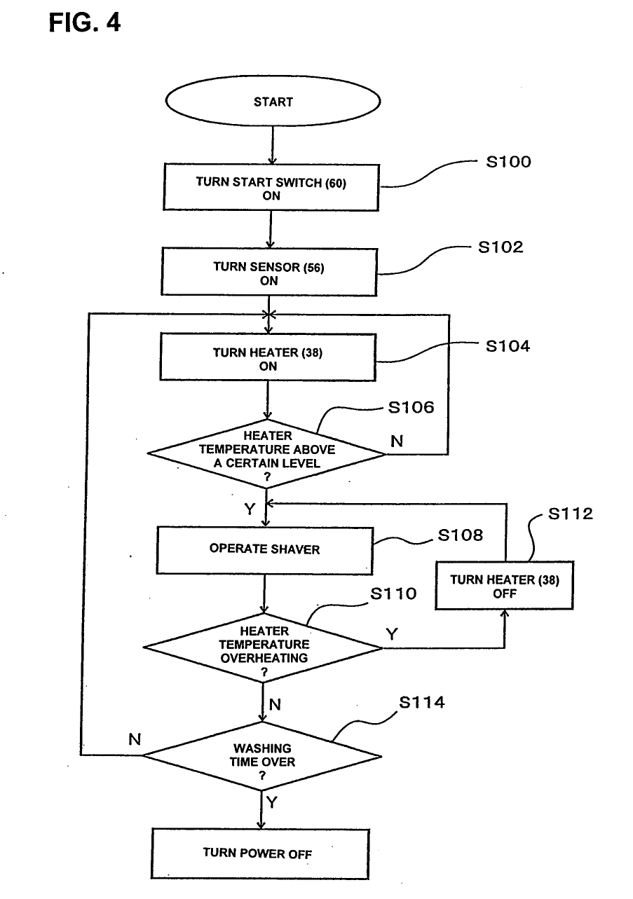

FIG. 1 shows, in cross-section, one embodiment of the washing apparatus according to the present invention before the start of washing. FIG. 2 shows, also in cross-section, the washing apparatus during washing with a part thereof omitted. FIG. 3 is a simplified schematic diagram thereof, and FIG. 4 is an operational flow chart of the washing apparatus.

In FIGS. 1 and 2, the reference numeral 10 is a main body of the washing apparatus (“washer main body”). The washer main body 10 has an upright section 12 in the vicinity of the central portion thereof. Behind this upright section 12, a concavity section 16 is formed so that it receives a washing liquid tank 14. In front of the upright section 12, a washing basin 20 is disposed so that an electric (rotary or reciprocating) shaver 18 is set in this washing basin 20.

The washing liquid tank 14 is provided with a valve 22 in the bottom. When the washing liquid tank 14 is set in the concavity section 16, the valve 22 opens, making it possible for the washing liquid inside the washing liquid tank 14 to be supplied to the washing basin 20. When the washing liquid tank 14 is removed from the concavity section 16, the valve 22 closes, so that the washing liquid is prevented from flowing out of the washing liquid tank 14.

The valve 22 is comprised of a valve element 24 and a protrusion 26. The valve element 24 passes through the bottom surface of the washing liquid tank 14 and ordinarily (when the washing liquid tank 14 is removed from the concavity section 16) closes the valve 22 (or closes the bottom opening of the tank 14), and the protrusion 26 is provided at the bottom of the concavity section 16 so that the protrusion 26, when the tank 14 is set in the concavity section 16, pushes up the valve element 24 and opens the valve 22 (or opens the bottom opening of the tank 14). Furthermore, between the opposing surfaces of the concavity section 16 and the bottom of the washing liquid tank 14, a liquid-tight liquid chamber 28 is formed so as to prevent the washing liquid from leaking out when the valve 22 is open. The washing liquid is conducted to the washing basin 20 from this liquid chamber 28 by a pipe 30.

The pipe 30 is made of a metal such as stainless steel. One end of the pipe is connected through a check valve 32 to the liquid chamber 28; and from this check valve 32, the pipe 30 extends out and returns, substantially horizontally, below the washing basin 20, then rises up inside the upright section 12, reversing at the upper end 34 so as to form an inverted U-loop and then descending, and finally passes through the wall of the washing basin 20 to communicate with the inside of the washing basin 20. To the horizontal portion 36 of the pipe 30 that loops out and back below the washing basin 20, an electric heater 38 is provided. The washing liquid is heated by this heater 38, and the temperature of the washing liquid heated by this heater 38, or, alternatively, the temperature of the heat provided by the heater 38, is detected by a temperature sensor 39 provided near the horizontal portion 36.

The electric shaver 18 is inserted from above into the washing basin 20 with the shaver head unit 40 thereof oriented downward, that is, turned upside down. At the bottom of the washing basin 20, a suitable number of projections 42 are provided for the purpose of positioning the shaver head unit 40 in the washing basin 20. The electric shaver 18 is one having a rotary inner cutter(s) or one having a reciprocating inner cutter(s) in the shaver head unit 40. The dimensions and shape of the washing basin 20 will differ so as to correspond to the electric shaver 18 to be washed.

The washing basin 20 has a liquid discharge port 44 in the bottom. This liquid discharge port 44 extends downward so as to avoid interfering with the horizontal portion 36 of the pipe 30 or with the heater 38 or the like. In the lower part of the washer main body 10, a liquid discharge tank 46 is provided detachably. This liquid discharge tank 46 can be pulled out in a direction parallel to the bottom surface of the washer main body 10, and it has an opening 48 in the upper portion so as to face upward below the liquid discharge port 44 of the washing basin 20 when the liquid discharge tank 46 is set in the washer main body 10. As a consequence, discharge liquid (or used (dirty) washing liquid remaining after washing has finished) passes through the washing basin 20, the liquid discharge port 44 and the opening 48 to be discharged into the liquid discharge tank 46 and accumulates in the discharge tank 46.

The electric shaver 18 has at its lower end (that is, at the end which is opposite from the shaver head unit 40 and is positioned at the upper end in FIGS. 1 and 2 because the electric shaver is set upside down) an electrically connecting acceptor (plug receptacle) 50. This acceptor (plug receptacle) 50 is one that receives the charging plug of a charger (not shown) when the battery inside the electric shaver 18 is charged (or one that receives the plug of a power cord when the electric shaver 18 is not a chargeable type).

When the shaver 18 is set in the washer main body 10, a plug 52 provided in the washer main body 10 is connected to this acceptor 50. More specifically, a plug support assembly 54 is provided on the upright section 12 of the washer main body 10 so as to slide up and down (or, alternatively, in the direction of attachment and detachment direction of the plug 52), and the plug 52 provided on the plug support assembly 54 is connected to and disconnected from the acceptor 50 of the shaver 18 in conjunction with the up and down movement of the plug support assembly 54. FIG. 1 shows the plug 52 of the plug support assembly 54 of the washer main body 10 being separated from the acceptor 50 of the shaver 18, and in FIG. 2 the plug 52 is connected to the acceptor 50.

Furthermore, a sensor 56 is attached to the upright section 12 of the washer main body 10. The sensor 56 is, for instance, a micro-switch that, based on the position of movement of the plug support assembly 54, detects the connection between the plug 52 of the washer main body 10 and the acceptor 50 of the shaver 18. The sensor 56 works, for example, such that at a position where the plug support assembly 54 has moved downward and the plug 52 is connected to the acceptor 50 of the shaver 18, a cam 58 provided on the plug support assembly 54 presses the contact of the sensor 56, thus turning on the sensor 56. Furthermore, a manual start switch 60 is provided in the top panel of the upright section 12. It is possible that the connection of the plug 52 with the acceptor 50 be detected electrically by a controller 62 provided in the washer main body 10 instead of by the cam 58 and the sensor 56 combination.

The controller 62, shown in FIG. 1, comprises a CPU (microcomputer), a power circuit, a heater temperature control circuit constituting a heater controller 63, and various input/output interfaces, etc. The power circuit is a commercially available power supply, which constitutes a constant voltage power supply for the CPU, a power supply for the heater 38, and a power supply for the drive of the electric shaver 18. As seen from FIG. 3, the outputs of the start switch 60, the temperature sensor 39, and the sensor 56, and the like are inputted into this controller 62, and the controller 62 further controls, via the heater controller 63, the volume of heat produced by the heater 38. In other words, the controller 62 controls the entirety of the washing apparatus, including the operation of the electric shaver 18 (more specifically, the rotation of the inner cutter(s) of the shaver).

FIG. 4 is an operational flow chart of an example of the control performed by the controller 62.

First, when the start of washing action is detected by the manual start switch 60 being turned on (step S100 in FIG. 4), the controller 62 starts the operation. The CPU, first of all, determines whether or not the electric shaver 18 is set in the washing basin 20 by the sensor 56 detecting the position of the plug support assembly 54 (step S102); and, if the shaver is properly set, then the controller 62 starts the heater 38 for heating (step S104).

The CPU of the controller 62 continually monitors the temperature sensor 39; and, when the heater temperature or the washing liquid temperature reaches a certain temperature (step S106), the CPU starts the motor of the electric shaver 18 to initiate the rotational or reciprocating action (step S108) of the inner cutter(s). When the heater temperature or washing liquid temperature has risen excessively (into an overheating condition) (step S110), the CPU stops the heating of the heater 38, or, alternatively, decreases the electrical current to the heater 38 (step S112), and then the CPU waits for the heater temperature to return to within the appropriate range. During the above-described process, the electric shaver 18 continues to be driven. The CPU always continues monitoring the washing time (step S114); and, when the set time period has elapsed, it turns the power supply off and terminates the washing.

The washing liquid flows down from the washing liquid tank 14 and enters the horizontal portion 36 of the pipe 30 through the check valve 32 by gravity because of the water level differential between the washing liquid level in the washing liquid tank and in the pipe, and the washing liquid thus entered into the pipe 30 is heated by the heater 38. When the washing liquid boils due to the heating by the heater 38, the boiled washing water rises to the upper end 34 of the pipe 30 and is sprayed into the interior of the washing basin 20 from the spray nozzle 30A which is at the tip end of the pipe 30. When the washing liquid inside the horizontal portion 36 of the pipe 30 decreases, fresh washing water flows through the check valve 32 into the horizontal portion 36 due to the above-described water level differential. Fresh washing liquid thus enters the pipe 30 either continuously or intermittently and is heated to boiling by the heater 38, and it continues to be injected, either continuously or intermittently, into the washing basin 20.

The heated washing liquid inside the washing basin 20 enters the shaver head unit 40 of the electric shaver 18; and, while dissolving the skin oils adhering inside the shaver head unit 40 with heat, goes together with hair debris back into the washing basin 20. This used (dirty) washing liquid is discharged into the liquid discharge tank 46 from the liquid discharge port 44 of the washing basin 20 and is accumulated in the liquid discharge tank 46. During the washing process as described above, since the motor of the electric shaver 18 is driven, the shaver head unit operates, in other words the inner cutter(s) rotates or reciprocates, and thus the washing off of the contaminants is performed with even greater efficiency.

Furthermore, because the pipe 30 is bent so that the washing liquid passes through the upper end 34 which is higher than the highest liquid level of the washing liquid in the washing liquid tank 14, the washing liquid will not flow out to the washing basin 20 from the washing liquid tank 14 due to the water level differential between the washing liquid tank 14 and the washing basin 20 (or the spray nozzle 30A of the pipe 30), and the washing liquid is flows into the washing basin when it is boiled by the heater. Conversely, the used (dirty) washing liquid in the washing basin 20 will also not flow back to the washing liquid tank 14 due to the above-described structure of the pipe 30.

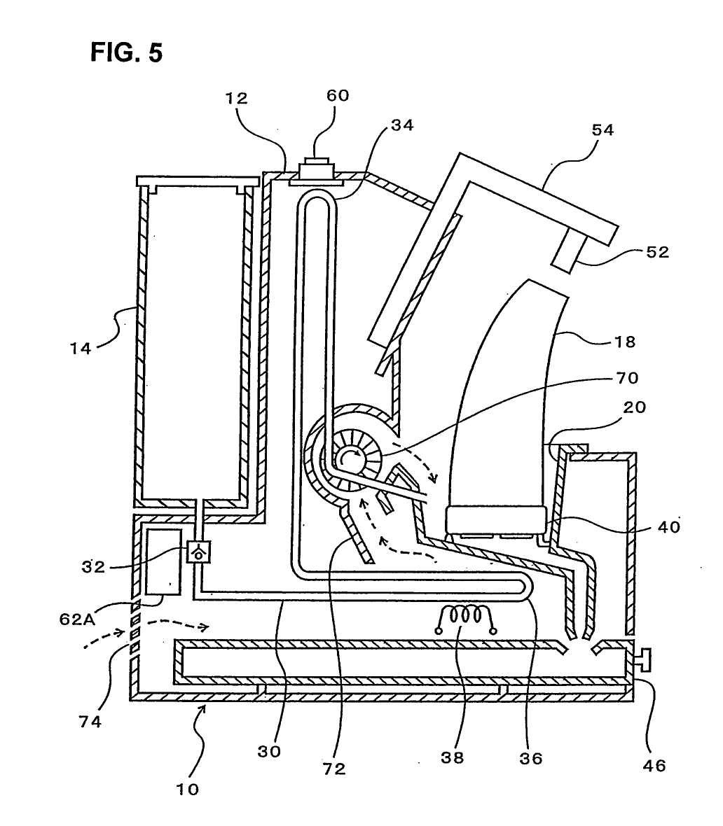

FIG. 5 shows, in lateral cross-section, another embodiment of the washing apparatus according to the present invention.

In the structure of FIG. 5, a blower 70 is provided as a drying means, and a warm air flow is sent, after the washing, to the shaver head unit 40, so that the shaver head unit 40 is rapidly dried. In this structure, the surrounding air (warm air flow) warmed by the heater 38 is conducted to the blower 70 by a guide panel 72 and then made to flow into the washing basin 20, thus heating and drying the shaver head unit 40 with the warm or heated air.

In this structure, a controller 62A is provided in the washer main body 10; and after the shaver head unit 40 has been washed by the washing liquid, the controller 62A lowers the temperature of the heater 38 or interrupts the power to the heater 38, so that only the blower 70 operates for a prescribed time period; and then, after the shaver head unit 40 is dried, the controller 62A terminates all of the washing processes.

Since the electrical circuitry for the structure of FIG. 5 is substantially the same as that of the structure shown in FIGS. 1-4, the blower 70 and the controller 62A are shown in FIG. 3.

In the structure of FIG. 5, air intake opening 74 is provided in the side panel of the washer main body 10 so that the outside air is sucked into the washer main body 10 and heated by the heater 38. In FIG. 5, parts that are the same as those in FIG. 1 are indicated by the same reference numerals, and the descriptions thereof are not provided.

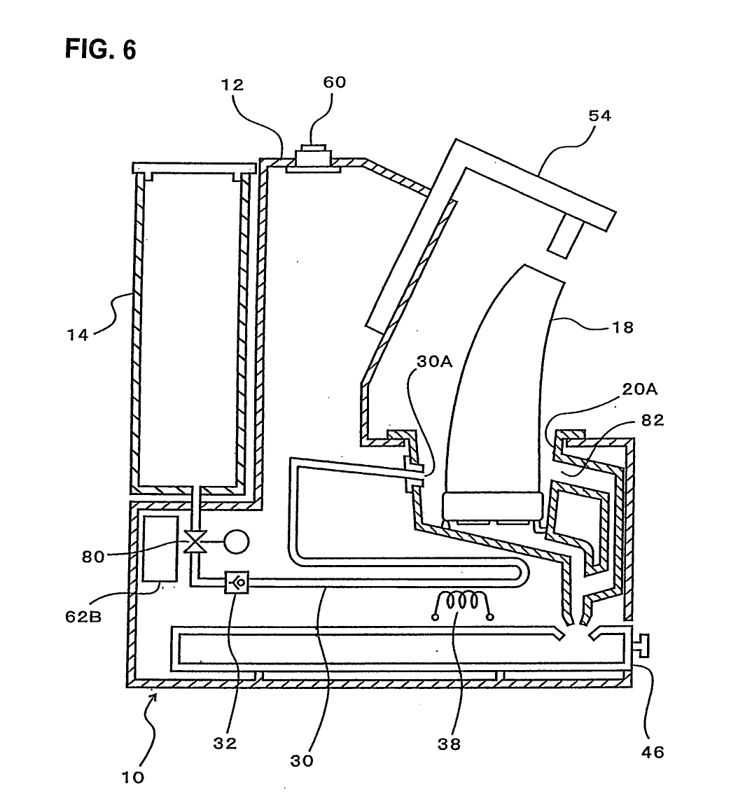

FIG. 6 shows still another embodiment of the washing apparatus of the present invention.

In the structure of FIG. 6, instead of bending the pipe 30 at the upper end 34 which is at a position higher than the highest liquid level in the washing liquid tank 14, a solenoid on-off valve 80 is provided in the pipe 30. A controller 62B ordinarily (when washing is not in progress) closes the solenoid on-off valve 80; and it opens the solenoid on-off valve 80, when washing is being done, and causes the heater 38 to heat the washing liquid. The controller 62B controls the heater 38 and the entire washing apparatus in the same way as the controllers 62 and 62A.

In the washing apparatus of FIG. 6, the washing liquid in the pipe 30 is boiled by the heat produced by the heater 38, and hot water and steam are sprayed into the washing basin 20 for washing. In conjunction with this action, fresh washing liquid flows from the washing liquid tank 14, through the solenoid on-off valve 80 and the check valve 32, and into the pipe 30, so that such action is repeated either continuously or intermittently. When the washing is completed, the solenoid on-off valve 80 is closed.

In the structure of FIG. 6, washing liquid will not flow out of the washing liquid tank 14 to the pipe 30 or washing basin 20A when no washing is being done, and, conversely, used (dirty) washing liquid will not flow back into the washing liquid tank 14 from the washing basin 20A. Furthermore, an overflow port 82 is provided in the washing basin 20A so that it is located at a position higher than the spray nozzle 30A. As a result, when the washing liquid level inside the washing basin 20A rises, the used (dirty) washing liquid is conducted to the liquid discharge tank 46 from the overflow port 82, and the washing liquid will not overflow from the washing basin 20A.

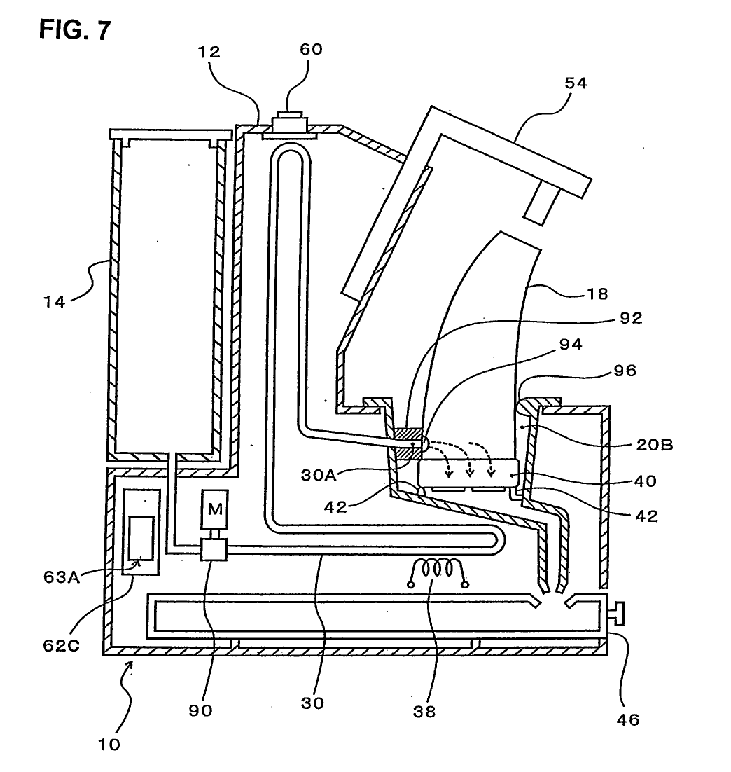

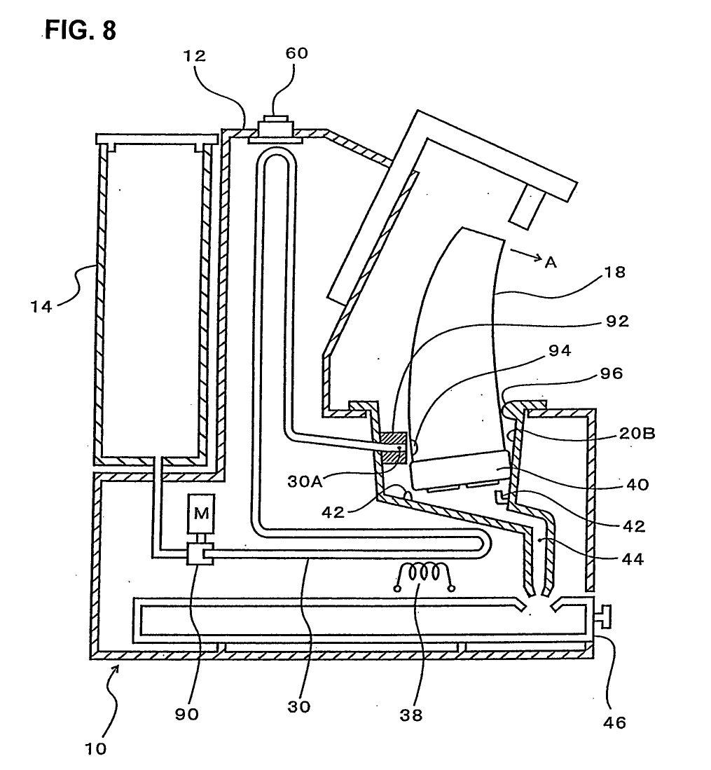

FIG. 7 shows still another embodiment of the washing apparatus of the present invention, and FIG. 8 shows the manner of setting an electric shaver in the washing apparatus.

In the structure of FIGS. 7 and 8, an electric pump 90 is provided as a washing liquid transporting means. More specifically, the electric pump 90 is provided in the pipe 30 between the washing liquid tank 14 and the heater 38, and this electric pump 90 is operated only during washing so as to send the washing liquid to the heater 38, where it is heated, and sending the heated washing liquid to the washing basin 20. A pump controller 63A for controlling this electric pump 90 is provided in a controller 62C.

In this washing apparatus of FIGS. 7 and 8, moreover, the spray nozzle 30A at the end of the pipe 30 is made to protrude into the washing basin 20, and a packing 92 is attached to the circumferential edge of this spray nozzle 30A. Furthermore, in the side wall of the shaver head unit 40 of the electric shaver 18, a liquid intake opening 94 is provided, which communicates between the interior and the exterior of the shaver head unit 40, so that when the electric shaver 18 is set in the washing apparatus, the liquid intake opening 94 is connected to and communicates with the spray nozzle 30A. The packing 92 is for preventing the washing liquid from leaking out to the periphery.

Furthermore, in this washing apparatus of FIGS. 7 and 8, a projection 96 is formed at the edge of the opening of the washing basin 20B so that it is located on the side opposite from the spray nozzle 30A. As a result, as seen from FIG. 8, the shaver 18, being upside down and tilted, is inserted into the washing basin 20B, and the upper part of the shaver that is on the opposite end from the shaver head unit 40 is turned to the side (turned to the right in FIG. 8 as indicated by arrow A) while keeping the upper part of the shaver head unit 40 against the projection 96; as a result, the liquid intake opening 94 of the shaver 18 is pressed against the spray nozzle 30A of the washing apparatus. When the shaver is thus set in the washing basin 20B, the shaver head unit 40 engages the projections 42 provided at the bottom of the washing basin 20B and is fixed in position.

Accordingly, in operation, the washing liquid heated by the heater 38 passes from the spray nozzle 30A of the pipe 30 and flows into the interior of the shaver head unit 40 through the liquid intake opening 94, so that the heated washing liquid washes the interior of the shaver head unit 40, passes out through the hair introduction slits or holes of the outer cutter(s) of the shaver, and then flows out of the shaver head unit into the washing basin 20B. After the washing, the used (dirty) washing liquid is discharged from the liquid discharge port 44 of the washing basin 20A and collected in the liquid discharge tank 46.

1. A washing apparatus for an electric shaver for flushing a shaver head unit of an electric shaver with a washing liquid, comprising:
a washer main body for holding said shaver head unit;
a washing liquid tank mounted in said washer main body and storing the washing liquid;
a pipe provided in said washer main body for conducting the washing liquid from the washing liquid tank to said shaver head unit;
a heater for heating the washing liquid passing through said pipe; and
a liquid discharge means for discharging used washing liquid that has washed said shaver head unit.

2. The washing apparatus for an electric shaver according to claim 1, wherein said liquid discharge means is a liquid discharge tank for accumulating washing liquid that has washed said shaver head unit and flows down by gravity.

3. The washing apparatus for an electric shaver according to claim 2, wherein said liquid discharge tank is detachable with respect to said washer main body.

4. The washing apparatus for an electric shaver according to claim 1, wherein
said washer main body is provided with a washing basin for holding said electric shaver so that the shaver head unit thereof is oriented downward, said basin enclosing said shaver head unit from below; and
said used washing liquid which has washed the shaver head unit is accumulated in said washing basin and conducted into said liquid discharge means.

5. The washing apparatus for an electric shaver according to claim 1, wherein the shaver head unit of said electric shaver is provided with a liquid intake opening for communicating an interior and an exterior of the shaver head unit, so that the washing liquid flows into the interior of the shaver head unit through said liquid intake opening.

6. The washing apparatus for an electric shaver according to claim 4, wherein
said washing basin is formed with a liquid discharge port provided in a bottom thereof and an overflow port provided above said overflow port; and
used washing liquid is discharged from said liquid discharge port when a liquid surface of said used washing liquid accumulating in said washing basin is at or below a certain level and is discharged from both said liquid discharge port and the overflow port when said liquid surface is above said certain level.

7. The washing apparatus for an electric shaver according to claim 1, further comprising, in said pipe for conducting the washing liquid from said washing liquid tank to the shaver head unit of said electric shaver, a washing liquid transporting means for sending the washing liquid to said washing basin.

8. The washing apparatus for an electric shaver according to claim 7, wherein said washing liquid transporting means is comprised of
a heater for heating the washing liquid at a position lower than said washing liquid tank and is provided midway along said pipe, and
a check valve provided between said pipe and the washing liquid tank.

9. The washing apparatus for an electric shaver according to claim 7, wherein said washing liquid transporting means is comprised of an electrical pump provided midway along said pipe for conducting the washing liquid from said washing liquid tank to the shaver head unit of said electric shaver.

10. The washing apparatus for an electric shaver according to claim 1, wherein said pipe is bent so that a part thereof passes through a position which is higher than a highest liquid level in said washing liquid tank.

11. The washing apparatus for an electric shaver according to claim 1, wherein said pipe is provided with an on-off valve for controlling a flow of the washing liquid from said washing liquid tank.

12. The washing apparatus for an electric shaver according to claim 1, further comprising
a temperature sensor for detecting at least one of a temperature of the washing liquid conducted to the shaver head unit of said electric shaver and a temperature of said heater; and
a heater controller for controlling said heater so that a temperature detected by said temperature sensor is made a target set temperature.

13. The washing apparatus for an electric shaver according to claim 9, further comprising
a temperature sensor for detecting a temperature of the washing liquid conducted to the shaver head unit of said electric shaver; and
a pump controller for controlling said electric pump so that a temperature of the washing liquid detected by said temperature sensor is made a target set temperature.

14. The washing apparatus for an electric shaver according to claim 1, further comprising a drying means for drying, after washing, the shaver head unit of said electric shaver.

15. The washing apparatus for an electric shaver according to claim 14, wherein said drying means is a heater for heating the shaver head unit.

16. The washing apparatus for an electric shaver according to claim 15, wherein a heater for heating the washing liquid doubles as said heater of said drying means.

17. The washing apparatus for an electric shaver according to claim 14, wherein said drying means is a blower for sending a warm air flow to the shaver head unit of said electric shaver.

18. The washing apparatus for an electric shaver according to claim 17, wherein said blower sends a warm air flow, heated by said heater for heating the washing liquid, to the shaver head unit of said electric shaver.

19. The washing apparatus for an electric shaver according to claim 1, further comprising a controller for, while said electric shaver held in said washer main body is being washed, turning on a power of said electric shaver for a prescribed period of time and causing the shaver head unit to operate.

20. The washing apparatus for an electric shaver according to claim 14, further comprising a controller for, while said electric shaver held in said washer main body is being washed, turning on a power of said electric shaver for a prescribed period of time and causing the shaver head unit of said electric shaver to operate and further causing said drying means to operate for a prescribed period of time after washing.

21. The washing apparatus for an electric shaver according to claim 1, wherein the washing liquid is an aqueous solution containing a detergent.
